(19) United States
(12) Patent Application Publication
(10) Pub. No.: US 2017/0154611 A1
(43) Pub. Date: Jun. 1, 2017

(54) IMAGE PROCESSING APPARATUS, METHOD OF CONTROLLING SAME, AND NON-TRANSITORY COMPUTER-READABLE STORAGE MEDIUM

(71) Applicant: CANON KABUSHIKI KAISHA, Tokyo (JP)

(72) Inventor: Yuki IGARASHI, Tokyo (JP)

(21) Appl. No.: 15/348,143

(22) Filed: Nov. 10, 2016

(30) Foreign Application Priority Data
Nov. 26, 2015 (JP) 2015-230693

(51) Int. Cl. G09G 5/391; G09G 5/393; G06T 3/40

(52) U.S. Cl. CPC G09G 5/391; G06T 3/4007; G09G 5/393

(57) ABSTRACT

An image processing apparatus that performs image processing on an image, writes a parameter used for performing the image processing to a memory, uses, out of a plurality of parameters used to perform the image processing, the parameter written to the memory to interpolate and generate a parameter not written to the memory, and performs the image processing by using the parameter written to the memory and the parameter interpolated and generated by using the parameter written to the memory.

### BACKGROUND OF THE INVENTION

Field of the Invention

The present invention relates to an image processing apparatus, a method of controlling the same, and a non-transitory computer-readable storage medium.

Description of the Related Art

In conjunction with an increase in resolution of images, a data amount of image processing parameters for performing image processing at high precision is increasing. For a conventional image processing apparatus, configuring by using two buffers to store image processing parameters is common. Such an image processing apparatus often updates an image processing parameter by a method such as the following. Specifically, out of the two buffers, during a period in which the image processing apparatus is performing image processing of a current frame while reading image processing parameters from one buffer, the image processing apparatus updates the image processing parameters of the other buffer. After the parameter update, the image processing apparatus switches buffers and performs image processing by using the parameters of the updated buffer.

However, a method for switching two buffers in this way has a problem in the cost incurred for the buffers. Japanese Patent Laid-Open No. 2013-205461 discloses a method for reducing cost by configuring a single buffer that had conventionally been configured by two buffers. The image processing apparatus of PTL1 configures a single buffer, and updates image processing parameters of the buffer during a vertical blanking period in which image processing is not performed.

Due to image processing such as resolution conversion processing, a vertical blanking period for a processing target image may become short. In addition, image processing parameters having a large data amount are normally stored in a main memory inside and outside of an image processing apparatus. In such a case, updating of the image processing parameters uses a DMA (Direct Memory Access) controller or the like to perform a transfer from the main memory to the buffer of the image processing apparatus.

However, when a memory bandwidth at a time of transfer cannot be sufficiently allocated or when the vertical blanking period is short, there are cases when updating of all image processing parameters during one vertical blanking period does not complete. If updating of image processing parameters does not complete during one vertical blanking period, the image processing apparatus uses the image processing parameters that are in the middle of being updated for the current frame to perform image processing for the next frame. In such a case, because a difference occurs in a boundary between an image processing result for which the updated image processing parameters were used and an image processing result for which the not updated image processing parameters were used, there is a problem in that it becomes easy to see as image degradation.

### SUMMARY OF THE INVENTION

The present disclosure is something made in view of the aforementioned problem, and provides a technique for making it hard to see image degradation after image processing in a case of using parameters updated at a predetermined time to perform image processing.

According to one aspect of the present invention, there in provided an image processing apparatus that performs image processing on an image, which comprises: a writing unit configured to write a parameter used for performing the image processing to a memory; an interpolation unit configured to use, out of a plurality of parameters used to perform the image processing, the parameter written to the memory to interpolate and generate a parameter not written to the memory by the writing unit; and an image processing unit configured to perform the image processing by using the parameter written to the memory by the writing unit and the parameter interpolated and generated by the interpolation unit by using the parameter written to the memory.

Further features of the present invention will become apparent from the following description of exemplary embodiments (with reference to the attached drawings).

### BRIEF DESCRIPTION OF THE DRAWINGS

FIG. 1 illustrates an illustrative configuration of an image processing apparatus in a first embodiment.

FIG. 2 illustrates an illustrative configuration of a parameter update unit.

FIG. 3 illustrates a separate illustrative configuration of a parameter update unit.

FIG. 4 illustrates a flowchart of processing in the first embodiment.

FIG. 5 illustrates a flowchart of processing in the first embodiment.

FIG. 6 illustrates conversion curves of parameters before and after updating.

FIG. 7 illustrates a color conversion table in the first embodiment.

FIG. 8 illustrates an arrangement in a main memory of a color conversion table in the first embodiment.

FIG. 9 illustrates a first parameter update state of the first embodiment.

FIG. 10 illustrates first and second parameter update states of the first embodiment.

FIG. 11 illustrates conversion curves of parameters at a time when a first parameter update has completed.

FIG. 12 illustrates an example of parameters for before updating and after updating, of the first embodiment.

FIG. 13 illustrates an example of a conversion curve of parameters of the first embodiment.

FIGS. 14A and 14B illustrate flowcharts of processing in a second embodiment.

FIG. 15 illustrates an illustrative configuration of an image processing apparatus in a third embodiment.

### DESCRIPTION OF THE EMBODIMENTS

Below, with reference to the attached drawings, a detailed explanation is given for the present invention based on embodiments. Note that configurations illustrated in the following embodiments are merely examples, and the present invention is not limited to the illustrated configurations.

### First Embodiment

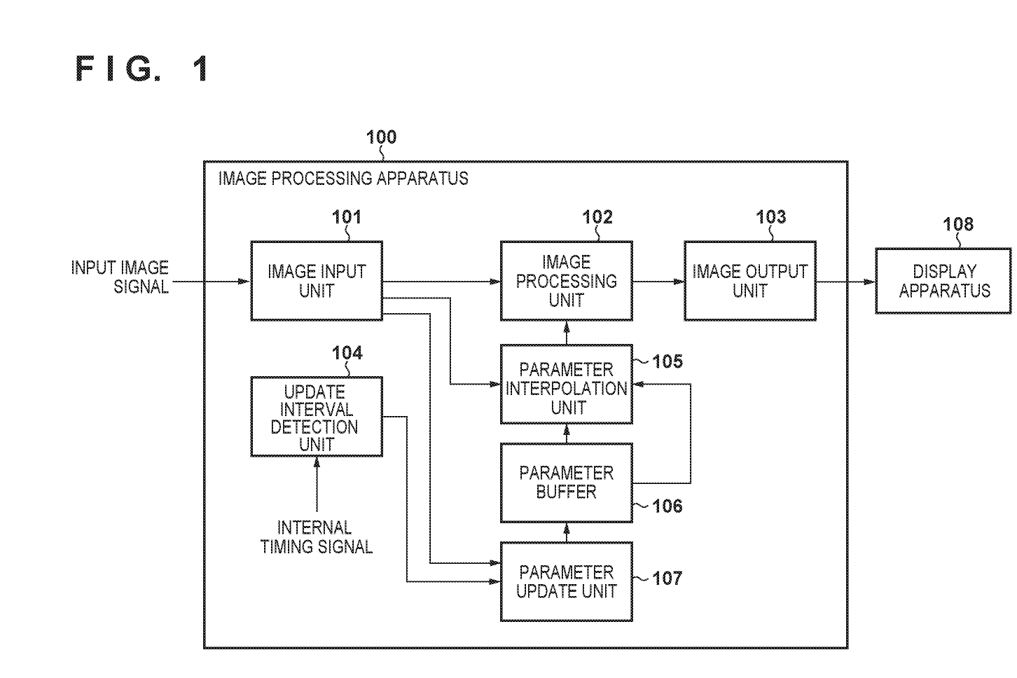

FIG. 1 is a view illustrating an example of a configuration of an image processing apparatus 100 in a first embodiment of the present invention. The image processing apparatus 100 in the present embodiment can use updated image processing parameters to interpolate and generate non-updated image processing parameters. These image processing parameters are parameters used by a later-described image processing unit 102, and are also simply called parameters below.

An image input unit 101 receives an input image signal from an external unit. This image signal is a signal of image data in individual image frames. The image input unit 101 performs analysis of a signal format, and outputs an image signal after analysis to the image processing unit 102. In addition, the image input unit 101 notifies an image signal input start (start of an image frame) to a parameter interpolation unit 105 and a parameter update unit 107. The image processing unit 102 performs image processing with respect to the image signal. In the present embodiment, the image processing unit 102 performs processing for color correcting an 8-bit pixel value in accordance with a correction curve. In the present embodiment, as a pixel value after color correcting, the image processing unit 102 outputs a pixel value corrected in accordance with a color conversion table based on the correction curve from an R pixel value of the input pixel. At a time of image processing, the image processing unit 102 reads parameters from a parameter buffer 106 via the parameter interpolation unit 105 or reads parameters stored by the parameter interpolation unit 105, and performs image processing. The image processing unit 102 outputs a frame after the image processing to an image output unit 103.

The image output unit 103 outputs an image signal that has been subject to image processing to a display apparatus 108. An update interval detection unit 104 detects a parameter update interval which is a time interval for updating parameters, and notifies the parameter update unit 107 of a start of the parameter update interval. In the present embodiment, a vertical blanking period of an image signal input to the image processing unit 102 is envisioned as a parameter update interval. The update interval detection unit 104 generates a start trigger signal at a time of start of the vertical blanking period of the image signal input by the image processing unit 102, and inputs it to the parameter update unit 107. Note that there is no necessity to limit the parameter update interval to a vertical blanking period, and it may be an interval other than for executing image processing by the image processing unit 102. For example, configuration may be taken such that, when a processing timing for each image process inside the image processing apparatus 100 is generated, the update interval detection unit 104 notifies a start of a parameter update interval based on an internal timing signal thereof.

When the image processing unit 102 performs reading of parameters from the parameter buffer 106, the parameter interpolation unit 105 returns parameters to the image processing unit 102. In the present embodiment, if updating is not finished for parameters the parameter interpolation unit 105 returns values interpolated from updated parameters, and returns updated parameters if the parameter updating is complete. To determine whether a parameter to refer to has been updated, the parameter interpolation unit 105 can receive parameter update information in the parameter buffer 106. In the present embodiment, parameters are divided into a plurality of sets, as described later. Therefore, the parameter interpolation unit 105 can receive information of whether each parameter set has been updated from the parameter buffer 106 (a memory). The parameter interpolation unit 105 obtains parameter update information when notification of an image signal input start is received from the image input unit 101.

The parameter buffer 106 is a memory for storing parameters used by the image processing unit 102, and is configured to be a single buffer in the present embodiment. The parameter update unit 107 updates parameters stored in the parameter buffer 106. The parameter update unit 107 starts parameter updating after detecting notification of a parameter update interval start that is notified by the update interval detection unit 104.

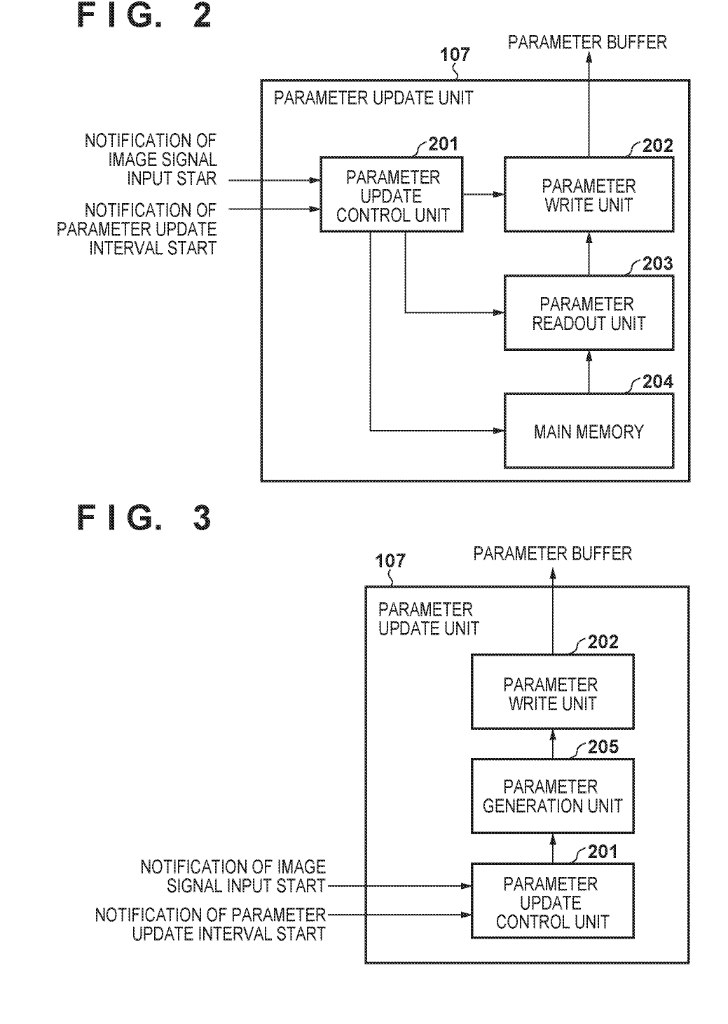

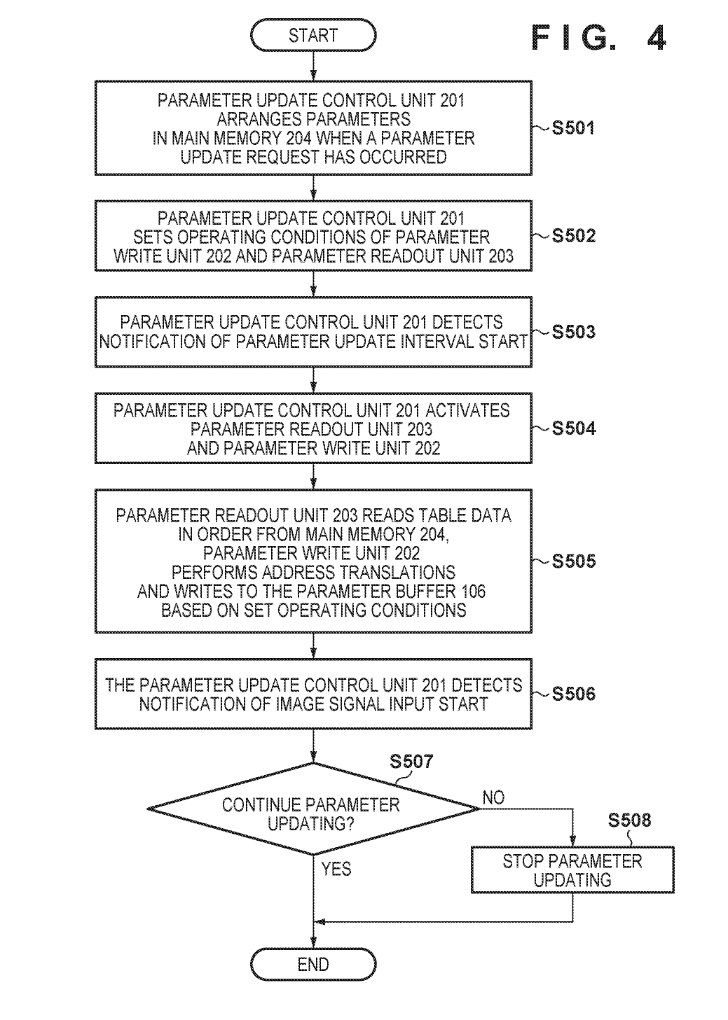

Next, FIG. 2 and FIG. 3 are used to give explanation in detail regarding a configuration of the parameter update unit 107. FIG. 2 and FIG. 3 are views that represent an example of a configuration of the parameter update unit 107. The parameter update unit 107 illustrated in FIG. 2 is configured from a parameter update control unit 201, a main memory 204, a parameter readout unit 203, and a parameter write unit 202.

The parameter update control unit 201 receives notification of an image signal input start from the image input unit 101, and receives a notification of a parameter update interval start from the update interval detection unit 104. The parameter update control unit 201 controls the parameter write unit 202 and the parameter readout unit 203 based on these notifications. For example, the parameter update control unit 201 sets, with respect to the parameter write unit 202, an order in which to write data to the parameter buffer 106. In addition, for example, the parameter update control unit 201 sets, with respect to the parameter readout unit 203, a start address for readout of data from the main memory 204, and also controls a transfer size for the readout as well as a readout operation start and stop.

The parameter write unit 202 writes to the parameter buffer 106 parameters read by the parameter readout unit 203 in accordance with the writing order set from the parameter update control unit 201. The parameter readout unit 203 reads parameter data from the main memory 204 in accordance with the read start address set by the parameter update control unit 201. The main memory 204 obtains and stores image processing parameters for setting to the parameter buffer 106 in accordance with control by the parameter update control unit 201.

In the present embodiment, the parameter write unit 202 and the parameter readout unit 203 are assumed to be configured by DMA (Direct Memory Access) controllers. However, there is no necessity to be limited to DMA controllers, and a CPU (Central Processing Unit) (not shown) in the image processing apparatus 100 may read parameters from the main memory 204 and write them to the parameter buffer 106.

FIG. 3 is a view that represents another example of a configuration of the parameter update unit 107. The parameter update unit 107 illustrated in FIG. 3 has a configuration that differs to FIG. 2 in not having a main memory 204, and having a parameter generation unit 205 in place of the parameter readout unit 203. The parameter generation unit 205 generates and obtains parameters to write to the parameter buffer 106. Note that, in the explanation below, the configuration of the parameter update unit 107 is presumed to be the configuration illustrated in FIG. 2, but by adding necessary modifications the following embodiment can be implemented even with the configuration illustrated in FIG. 3.

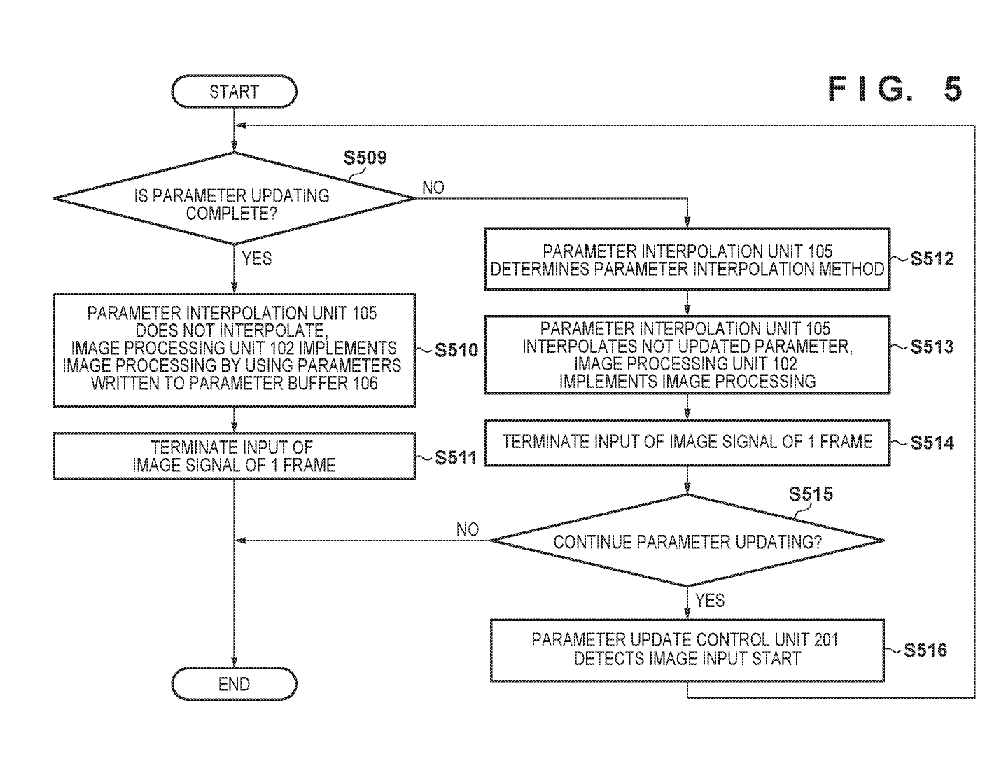

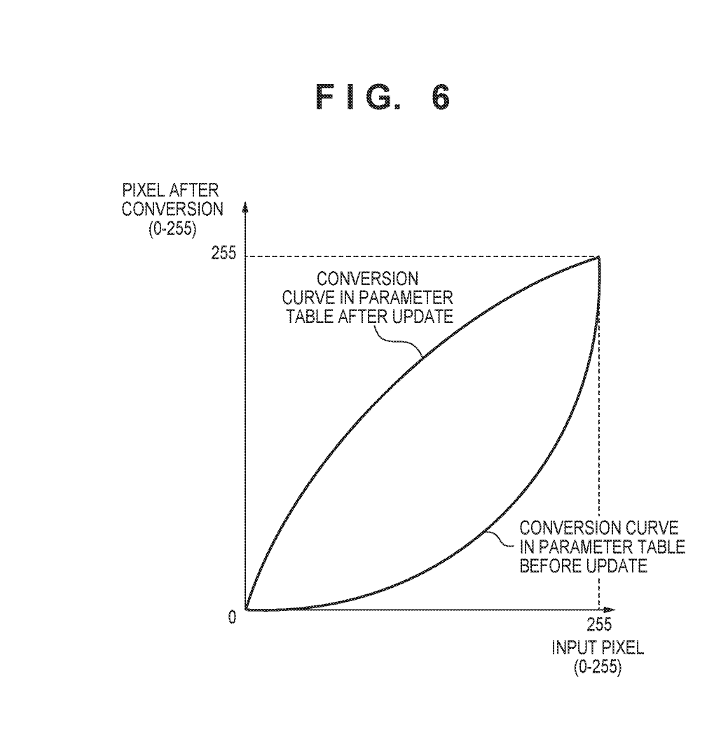

Next, FIG. 4 and FIG. 5 are used to describe processing of the image processing apparatus 100 in the first embodiment. FIG. 4 is a flowchart of processing for the parameter update unit 107 to perform parameter updating processing when a parameter update request is generated. In the present embodiment, a parameter update request can be generated in accordance with an operation by a user, a change of a color space or a resolution of a processing target image, properties of the image, or the like.

In FIG. 4, the parameter update control unit 201 arranges parameters in the main memory 204 when a parameter update request has occurred (step S501). The parameters are saved in a ROM region (not shown) inside and outside of the image processing apparatus 100, as table data of several patterns, for example. The parameter update control unit 201 selects one from these after the parameter update request is generated. In the present embodiment, the parameter update control unit 201 rearranges the parameters and stores them in the main memory 204 so that a parameter that can be interpolated is transferred first. Description regarding rearrangement of the parameters is given later.

Next, the parameter update control unit 201 sets operating conditions with respect to the parameter write unit 202 and the parameter readout unit 203 (step S502). In the present embodiment, as operating conditions, the parameter update control unit 201 sets a writing order to the parameter write unit 202, and sets a readout start address of the DMA controller and a readout size (transfer amount) to the parameter readout unit 203.

When a vertical blanking period starts, the update interval detection unit 104 notifies a parameter update interval start to the parameter update control unit 201. Receiving this, the parameter update control unit 201 detects the notification of the parameter update interval start (step S503). By detecting the notification of the parameter update interval start, the parameter update control unit 201 causes the parameter readout unit 203 and the parameter write unit 202 to activate (step S504).

Next, the parameter readout unit 203 reads the parameters from the main memory 204 in order. The parameter write unit 202 writes the parameters read by the parameter readout unit 203 to the parameter buffer 106. At this point, the parameter write unit 202 writes parameters while performing address translations based on the writing order set by the parameter update control unit 201 (step S505). Processing of step S505 means that parameter updating is being performed.

When an image signal is input to the image input unit 101, the image input unit 101 notifies an image signal input start to the parameter update control unit 201. Receiving this, the parameter update control unit 201 detects the notification of the image input start (step S506). Next, the parameter update unit 107 determines whether to continue parameter updating (step S507). In the present embodiment, continuing parameter updating is assumed (Yes in step S507). However, in a case of stopping the parameter updating (No in step S507), the parameter update control unit 201 performs control for stopping operation of the parameter readout unit 203 (step S508).

Next, description is given regarding FIG. 5. FIG. 5 is a flowchart for processing in a case in which the parameter update control unit 201 has detected notification of an image input start, and subsequently received a request for parameters from the image processing unit 102. Firstly, the parameter interpolation unit 105 determines whether parameter updating processing by the parameter update unit 107 is complete, in other words whether writing of the parameters to the parameter buffer 106 is complete. Based on this determination, the parameter interpolation unit 105 determines whether to perform interpolation (step S509).

When the parameter updating processing has completed (Yes in step S509), the parameter interpolation unit 105 returns parameters corresponding to the request to the image processing unit 102, and does not perform interpolation processing. The image processing unit 102 uses the parameters written to the parameter buffer 106 to implement image processing (step S510). Thereafter, an image signal for one image frame is input to the image processing apparatus 100, and processing terminates after image processing on the image signal by the image processing unit 102 (step S511).

Meanwhile, if the parameter updating processing has not completed (No in step S509), the parameter interpolation unit 105 determines an interpolation method for interpolating parameters that have not been updated—in other words parameters that have not yet been written to the parameter buffer 106 (step S512). If there is a request from the image processing unit 102 for parameters that have not been updated, the parameter interpolation unit 105 uses the interpolation method decided in step S512 to generate the parameters that have not been updated, and returns them to the image processing unit 102. The image processing unit 102 uses the parameters generated by interpolation to implement image processing (step S513).

Thereafter, image data for one image frame is input to the image processing apparatus 100, and processing terminates after image processing accompanying interpolation on the image signal by the image processing unit 102 (step S514). Next, similarly to step S507 the parameter update unit 107 determines whether to continue parameter updating (step S515). If not continuing parameter updating (No in step S515), the processing terminates. If continuing parameter updating (Yes in step S515), the parameter update unit 107 continues the parameter updating until an image signal input start is next received (step S516), returns to step S509 again, and repeats processing until all parameter updating completes.

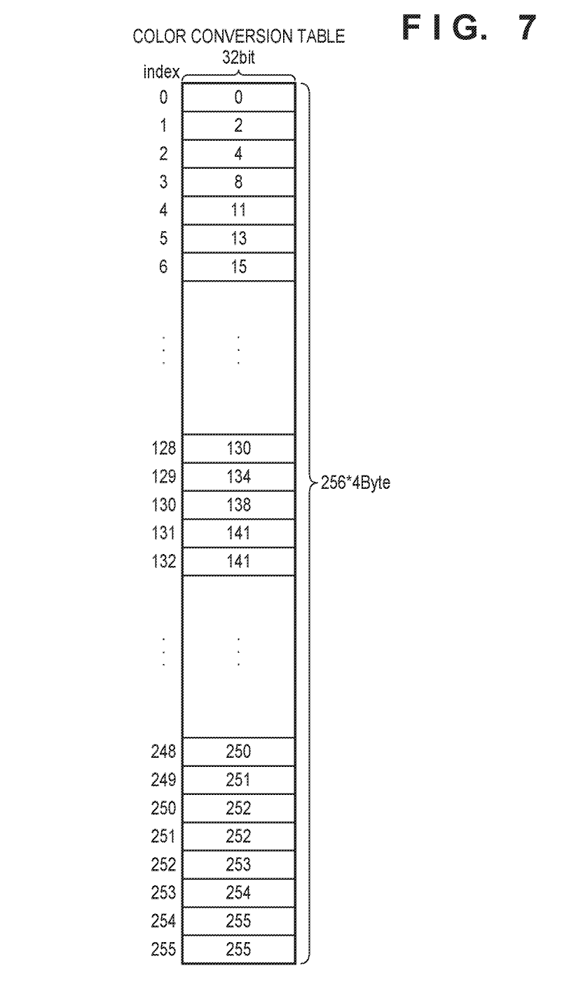

Next, FIG. 6 to FIG. 12 are used to give a description regarding processing by the parameter interpolation unit 105 for interpolating parameters that have not been updated, when updating of the image processing parameters (writing parameters) in the parameter buffer 106 is not complete.

FIG. 6 is a view for illustrating conversion curves for before parameters are changed and after parameters are changed, in the present embodiment. The conversion curves illustrated in FIG. 6 represent color conversion curves. The image processing unit 102 uses the conversion curve prior to the change to perform processing to make each pixel value smaller in relation to input pixel values of 0-255. In addition, the image processing unit 102 uses the conversion curve after the change to perform processing to make each pixel value larger in relation to input pixel values of 0-255. Specifically, this conversion processing is assumed to be conversion processing of an R (red) component.

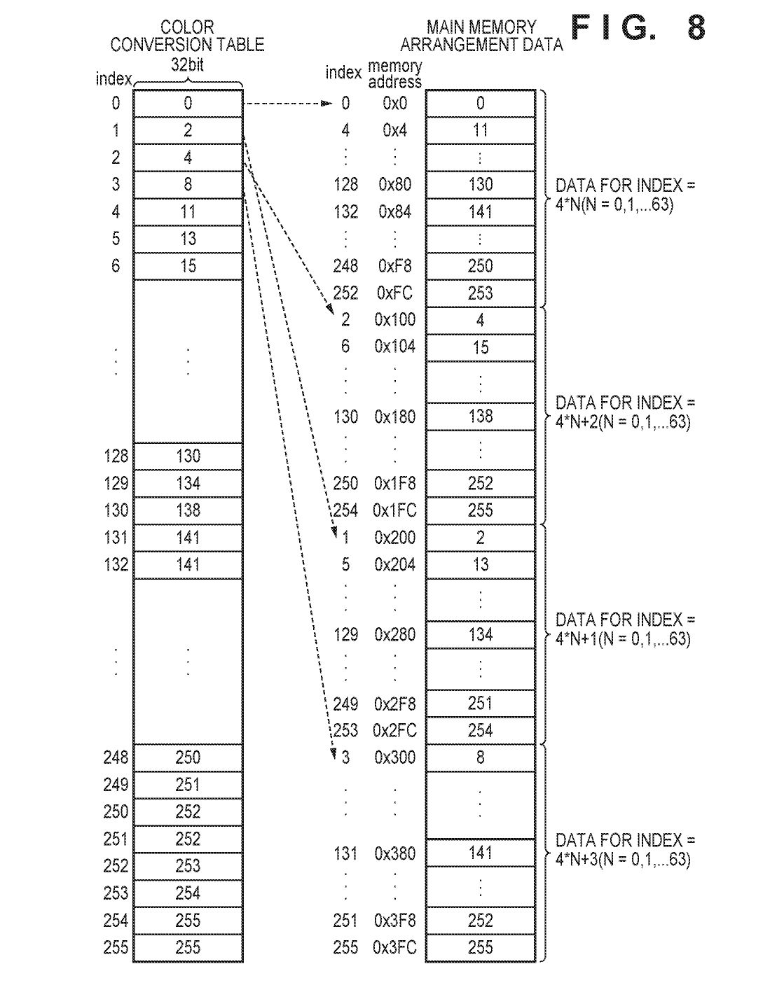

FIG. 7 is something that illustrates an example of a parameter table (a color conversion table). The index in the view represents R pixel values of 0-255. The parameter table of FIG. 7 has, as table data, pixel values output in correspondence to index. In addition, the parameter table of FIG. 7 has the size of a parameter (a pixel value output) set as 4 bytes (32 bits), and is configured by 4×256=1024 bytes. Note that a parameter table in the present embodiment is assumed to be that illustrated in FIG. 7, but it may be another table in which output information (in FIG. 7, 32-bit pixel values) output in correspondence with an identification number (index in FIG. 7) or identification information of input information is arranged.

According to the parameter table illustrated in FIG. 7, if an input R pixel value is 1, an R pixel value output after image processing becomes 2. In addition, if an input R pixel value is 3, the R pixel value output after image processing becomes 8.

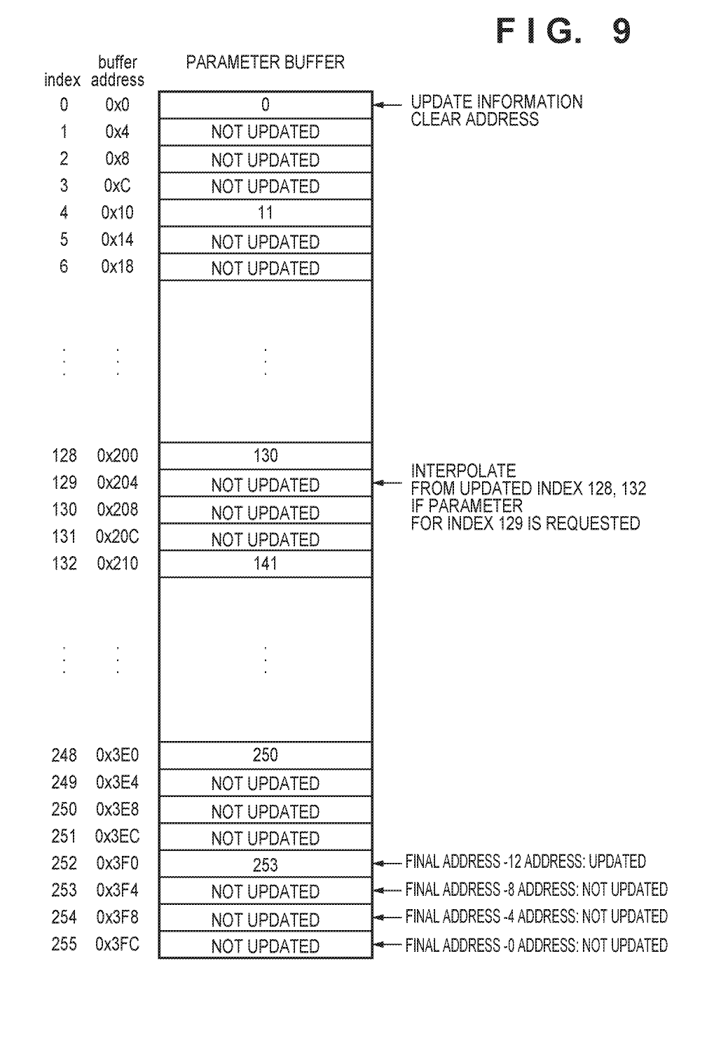

The table data illustrated in FIG. 7 is divided into four groups by the parameter update control unit 201, and stored in the main memory 204. FIG. 8 is a view illustrating an arrangement in the main memory 204 of a color conversion table in the present embodiment. According to the example illustrated in FIG. 8, parameter data illustrated in FIG. 7 is divided into 4 groups by the conditions of:
First parameter: 4*N (N=0, 1, . . . 256/4−1),
Second parameter: 4*N+2 (N=0, 1, . . . 256/4−1),
Third parameter: 4*N+1 (N=0, 1, . . . 256/4−1), and
Fourth parameter: 4*N+3 (N=0, 1, . . . 256/4−1). In other words, index is grouped into 4 intervals.

The parameter readout unit 203 starts operation in accordance with control by the parameter update control unit 201, and consecutively reads the first parameter set to the fourth parameter set based on the set operating conditions. The parameter write unit 202 converts write addresses from an order for table data divided as in FIG. 8 into an order for writing to the parameter buffer 106, and writes to the parameter buffer 106 for each group. In the present embodiment, transferring to the parameter buffer 106 is consecutively performed in transfer units indicated below, by the parameter readout unit 203 and the parameter write unit 202.

First transfer unit: write destination start address: 0x0, number of writes: 64, incremental step: 16

Second transfer unit: write destination start address: 0x8, number of writes: 64, incremental step: 16

Third transfer unit: write destination start address: 0x4, number of writes: 64, incremental step: 16

Fourth transfer unit: write destination start address: 0xc, number of writes: 64, incremental step: 16

When the parameter write unit 202 completes writing of all parameters to the parameter buffer 106, a state in which the color conversion table illustrated by FIG. 7 is stored in the parameter buffer 106 is reached. However, at a point in time where updating of some parameters is complete, updated parameters and parameters for which updating has not been performed are mixed in the parameter buffer 106.

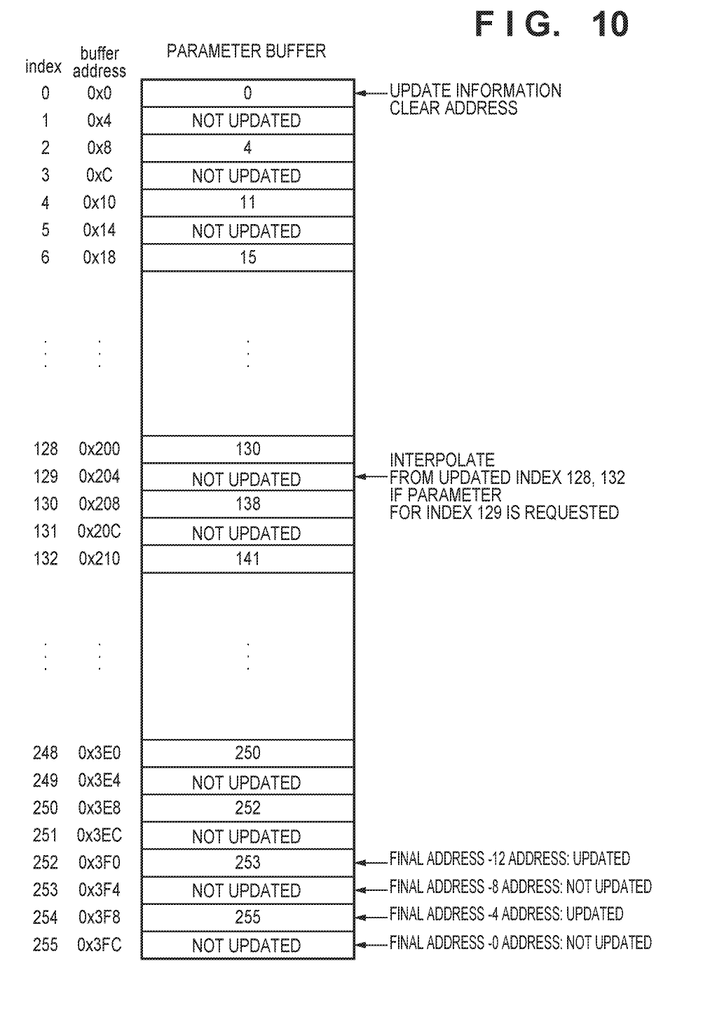

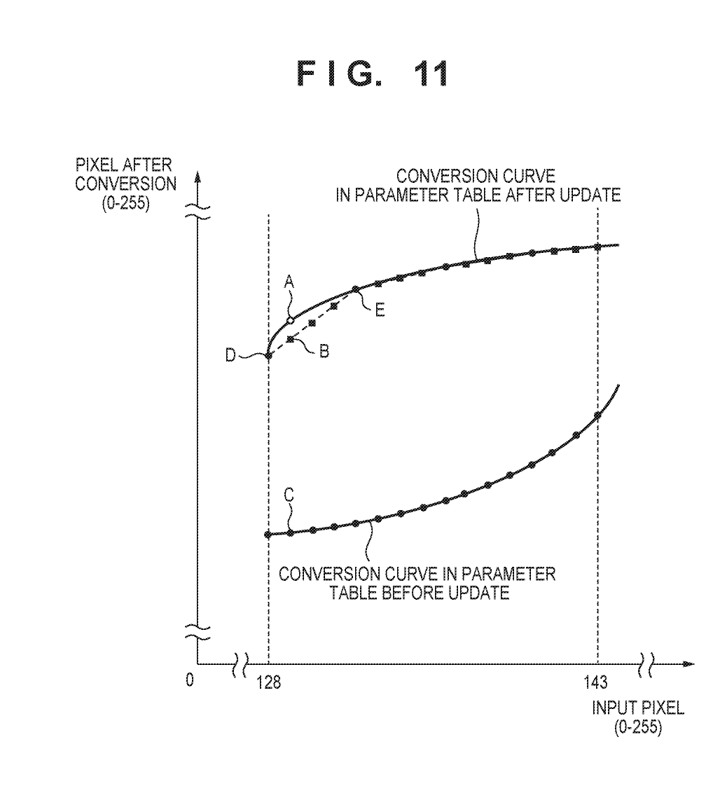

FIG. 9 and FIG. 10 illustrate examples of updating states in the parameter buffer 106. FIG. 9 illustrates a state in the parameter buffer 106 when updating of first parameters is complete. As illustrated in FIG. 9, when a first parameters update has completed, parameters of index=4N (N=0−63) of the parameter buffer 106 are updated. In the parameter buffer 106, parameters for index=4N (N=0−63) are written to the 0x10 address. If there is a write to a final address—12 addresses of the parameter buffer 106, the parameter interpolation unit 105 recognizes that the first parameters update has completed in accordance with parameter update information.

After the completion of the first parameters update, when the image processing unit 102 starts image processing, a parameter before the update is written to a parameter for index=129 which has not been updated. When the image processing unit 102 refers to the parameter for index=129, the parameter interpolation unit 105 uses a parameter 130 for index=128 and a parameter 141 for index=132 which have been updated to generate an interpolation value. The parameter interpolation unit 105 returns the generated value as the parameter for index=129.

FIG. 10 illustrates a state in the parameter buffer 106 when updating of first parameters and second parameters is complete. If there is a write to a final address—4 addresses of the parameter buffer 106, the parameter interpolation unit 105 recognizes that the second parameters update has completed in accordance with parameter update information. After the completion of the second parameter set update, when the image processing unit 102 starts image processing, the parameter interpolation unit 105 uses the parameter 130 for index=128 and a parameter 135 for index=130 which have been updated to generate an interpolation value. The parameter interpolation unit 105 returns the generated value as the parameter for index=129.

If there is a parameter update request, the parameter interpolation unit 105 clears the parameter update information for the parameter buffer 106. In the present embodiment, if there was a write to a 0x0 address of the parameter buffer 106 as illustrated in FIG. 9 and FIG. 10, the parameter interpolation unit 105 clears the parameter update information. When an initial parameter is written to the parameter buffer 106, the parameter interpolation unit 105 recognizes all parameters as not updated. Thereafter, the parameter update information is updated each time writing of final data for each parameter set is performed.

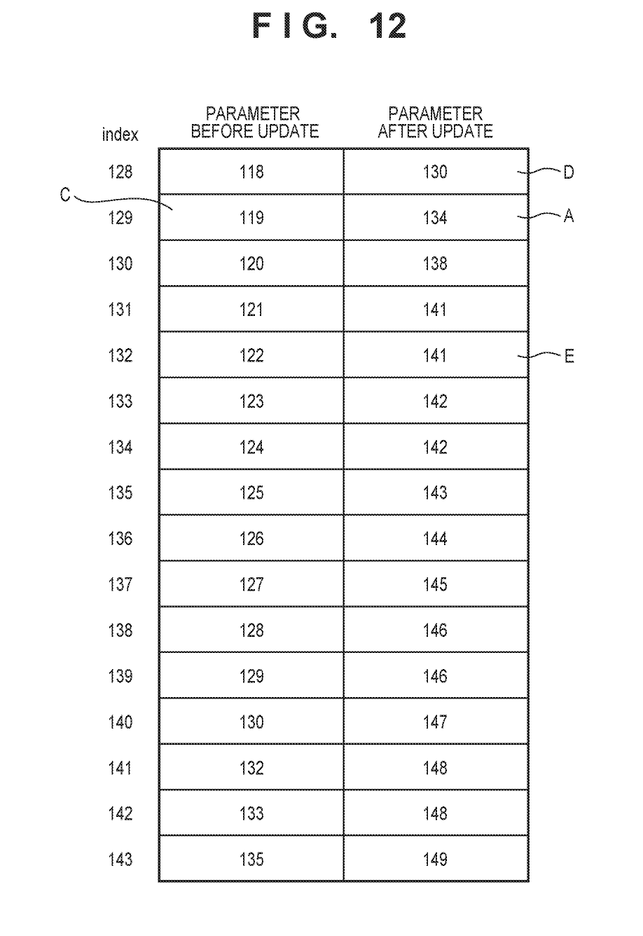

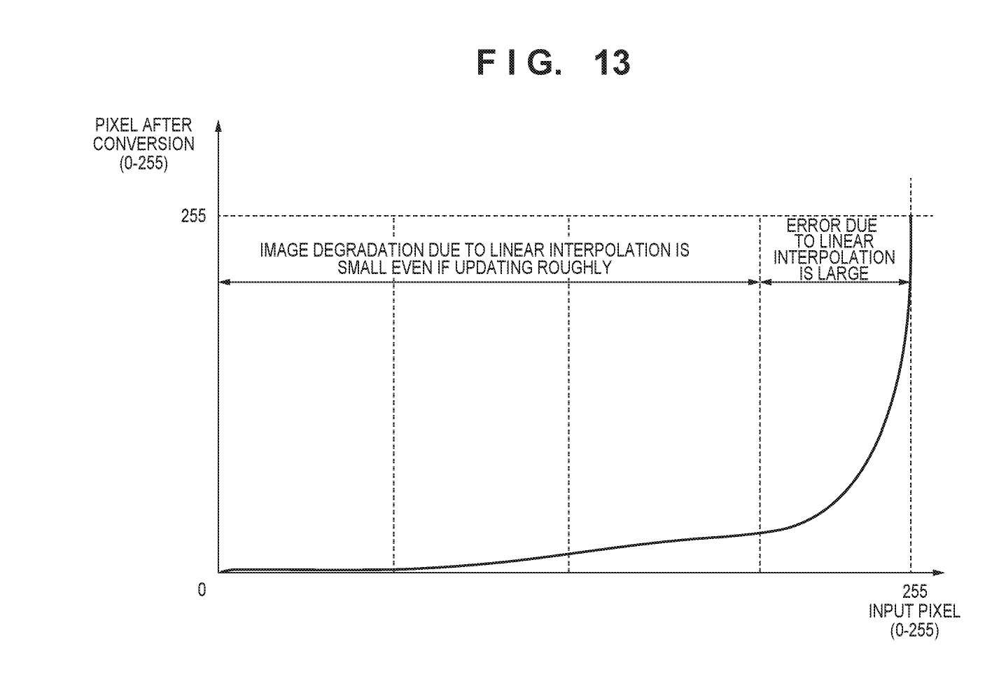

FIG. 11 is a view illustrating conversion curves of parameters at a time when a first parameter update has completed. FIG. 11 illustrates, at a time when the first parameter update has completed, a curve for portions of input pixel values 128-143 of FIG. 6 and a conversion curve for parameters before updating. FIG. 12 illustrates an example of parameters for before updating and after updating in a portion for input pixel values 128-143.

It is assumed that, when the first parameter update completes, an image signal is input to the image input unit 101, and the image processing unit 102 refers to a parameter for A at FIG. 11. Because the parameter for A is not updated, in a conventional example where interpolation is not performed, C which is a parameter table value for before updating is read. Because a difference between a case of referring to C and a value after a color conversion for a case of referring to A which should be actually referred to is large, an inconsistency between image processing for a case of referring to C and a parameter for a case of referring to parameters after updating occurs, and image degradation occurs. If the image processing unit 102 attempts to refer to A which is not updated, the parameter interpolation unit 105 returns, as a parameter, B which is interpolated from parameters D and E which have been updated. By this, even if the parameter for A is not updated, it is possible to obtain a value having an error that is smaller than in a case of referring to C.

In the aforementioned example, the parameter interpolation unit 105 uses two adjacent points and uses an approximation by a linear function, but may use approximation that uses a plurality of updated parameters. In addition, the parameter interpolation unit 105 may return the value of any one point of updated parameter data unchanged. In addition, the parameter interpolation unit 105 may use approximation by a second order or higher polynomial.

Below, an interpolation method in the present embodiment is illustrated. Interpolation data is set to D, a number of parameter elements is set to N, reference parameter table data is set to T[N], an index of reference parameters is set to i (a value of any of 0, 1, . . . N-1) and an updated parameter update interval is set to Step. In addition, processing for rounding down a decimal point of a decimal value F to give an integer is expressed by ROUNDDOWN(F), and a remainder for when a value A is divided by B is expressed as mod(A, B). In addition, a parameter at a time of interpolation 1 is set to P1=T[ROUNDDOWN(i/Step)* Step], and a parameter at a time of interpolation 2 is set to P2=T[ROUNDDOWN(i/Step)*Step+Step] (where if i=N-Step, P2=P1 is set. Another interpolation method may be used). In this case, the interpolation data D is obtained by

D=T[P1]+(T[P2]−T[P1])/Step*mod(i, Step).

Here, if the parameters are divided into four as in FIG. 8, the updated parameter update interval Step becomes 4 when the first parameter update completes and becomes 2 when the second parameter update completes. In addition, when the third parameter update completes it becomes 2 again, and when the fourth parameter update completes interpolation is not performed.

Description is given of an example of using the present interpolation method to interpolate the parameter, as illustrated in FIG. 9, for index=129 that is not updated, from the first parameters after the updating.

Letting N=256, i=129, and Step=4:

P1=T[ROUNDDOWN(129/4)*4)]=T[128]=130

P2=T[ROUNDDOWN(129/4)*4+4)]=T[132]=141

D=130+(141−130)/4*1=132.75. Here, in the present embodiment, a value after rounding and interpolation is set to be 133. Regarding a processing method for fractions, rounding down or rounding up may be used.

Description is given of an example of using the present interpolation method to interpolate the parameter, as illustrated in FIG. 10, for index=129 that is not updated, from the first parameters and the second parameters after the updating.

Setting N=256, i=129, and Step=2,

P1=T[ROUNDDOWN(129/2)*2)]=T[128]=130

P2=T[ROUNDDOWN(129/2)*2+2)]=T[130]=138

D=130+(138−130)/2*1=134.

In this way, by updating after dividing parameters into a predetermined plurality of numbers, even if an image signal is input and image processing is performed at a point in time when a parameter update amount is low, it is possible to interpolate parameters that have not been updated so as to maintain overall precision. In addition, if many parameters are updated, it is possible to obtain interpolation values for which an error is small.

In the present embodiment, an example of dividing parameters into 4 was described, but it can be into any number if it is greater than or equal to 2. For example, in a case of desiring to maintain consistency by interpolating without referring to parameters that have not been updated even if precision falls and a period from a start of a parameter update interval until the start of an image signal input is short, a number of divisions may be increased to 16, 32, or the like. In addition, configuration may be taken to divide into a large number of divisions in advance, or dynamically divide into a number of division suitable for a length of the vertical blanking period which is the parameter update interval, a memory bandwidth, or the like.

In addition, a transfer order for divided parameters may be changed dynamically. A case in which R pixel values are highly distributed near a low tone from a statistic of the image is considered, for example. In such a case, configuration may be taken such that the parameter update unit 107 first updates first parameters, then updates in an order of ¼ of the second parameters (0-63), ¼ of the third parameters (0-63), and ¼ of the fourth parameters (0-63).

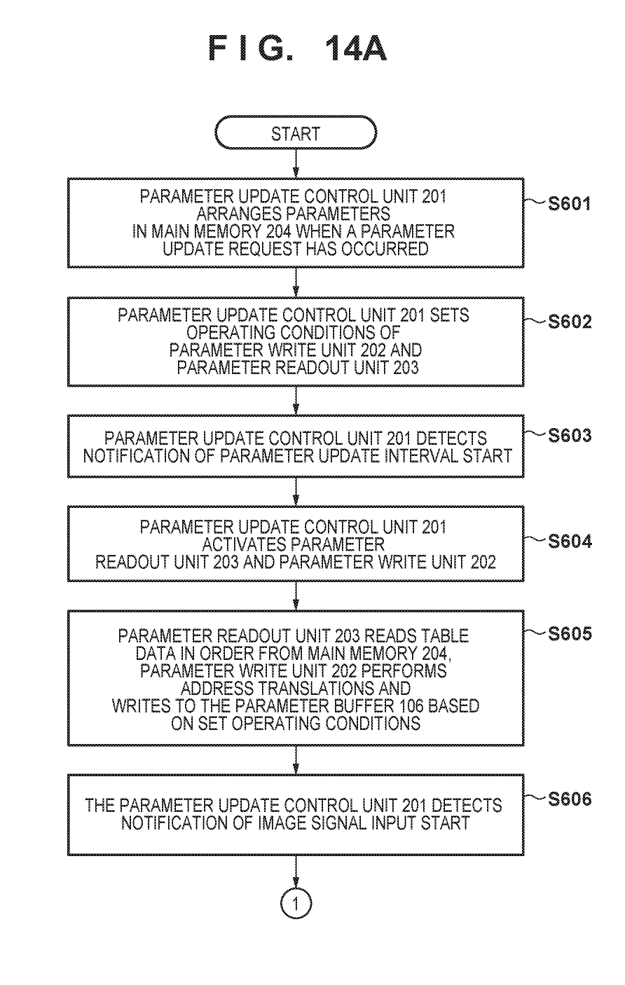

In addition, a transfer order may be dynamically changed from a features of parameters (a conversion curve). FIG. 13 illustrates an example of a color conversion curve. From a color conversion curve as illustrated in FIG. 13, if there is a bias in a portion for which change is large, the parameter update unit 107 may update a portion for which change is small at ⅛ precision and update all parameters for the portion for which change is large.

In addition, in the present embodiment, description was given of an example in which a DMA controller is used in parameter reading, but a CPU may be used. In addition, the parameter readout unit 203 may perform random access without arranging parameters in a transfer order. In such a case, there is a decrease in memory access efficiency in a case of reading by a DMA controller or a decrease in cache efficiency in a case of reading by a CPU.

When writing is performed to the 0x0 address of the parameter buffer 106, the parameter interpolation unit 105 clears the parameter update information. In addition, the parameter interpolation unit 105 can know that updating of the first parameters is complete by the final address—12 addresses of the parameter buffer 106 being updated. Similarly, the parameter interpolation unit 105 can know that updating of the second parameters is complete by the final address—4 addresses being updated, that updating of the third parameters is complete by the final address—8 addresses being updated, and that updating of the fourth parameters is complete by the final address—0 addresses being updated.

In the present embodiment, because the fourth parameter update is complete if the final address—0 addresses is updated, the parameter interpolation unit 105 does not perform interpolation. If the final address—4 addresses is updated, the parameter interpolation unit 105 performs interpolation of not updated parameters in accordance with the first parameters and the second parameters. In other cases the parameter interpolation unit 105 performs interpolation of not updated parameters in accordance with the first parameters.

If, from divided parameters, updating is not complete for even one at a time of an image signal input start, the parameter interpolation unit 105 may perform interpolation processing in accordance with parameters before or after updating or parameters before updating. In such a case, the quality of the image signal after image processing will deteriorate. If a parameter update request occurs after such update processing, the parameter update control unit 201 may perform control such as increasing a number of divisions, and setting a minimum size for which transfer is necessary to low from the start of a parameter update interval until the start of an image signal input.

Note that, in the present embodiment, the parameter interpolation unit 105 determines the interpolation method in accordance with parameter writing four sets of starts and ends of the parameter buffer 106, but another method may be used. For example, configuration may be such that all pieces of the parameter update information can be notified from the parameter buffer 106 to the parameter interpolation unit 105. In such a case, even if the parameters are randomly updated, the parameter interpolation unit 105 can perform interpolation by using adjacent updated parameters.

In this way, according to the present embodiment, if parameter updating completes during the vertical blanking period which is the parameter update interval, it is possible to perform image processing without image degradation, and if the parameter updating is not completed it is possible to use updated parameters to perform image processing having low image degradation. By virtue of such a configuration, it becomes possible to cause image degradation after image processing to be hard to see even if parameters for the image processing are not updated.

Note that the parameter update unit 107 can stop transfer of parameters if parameter updating is not in time to complete during the parameter update interval. In addition, if an image signal input is started the parameter update unit 107 may, even if updating of parameters has not completed, stop parameter updating and, from the termination of the image signal input until a next image signal input starts, perform updating of parameters for the next the image signal input. In addition, if parameter updating is not in time for the image signal input start and a parameter being updated becomes unnecessary in a subsequent image frame, the parameter update unit 107 can reserve memory bandwidth by stopping the parameter update.

### Second Embodiment

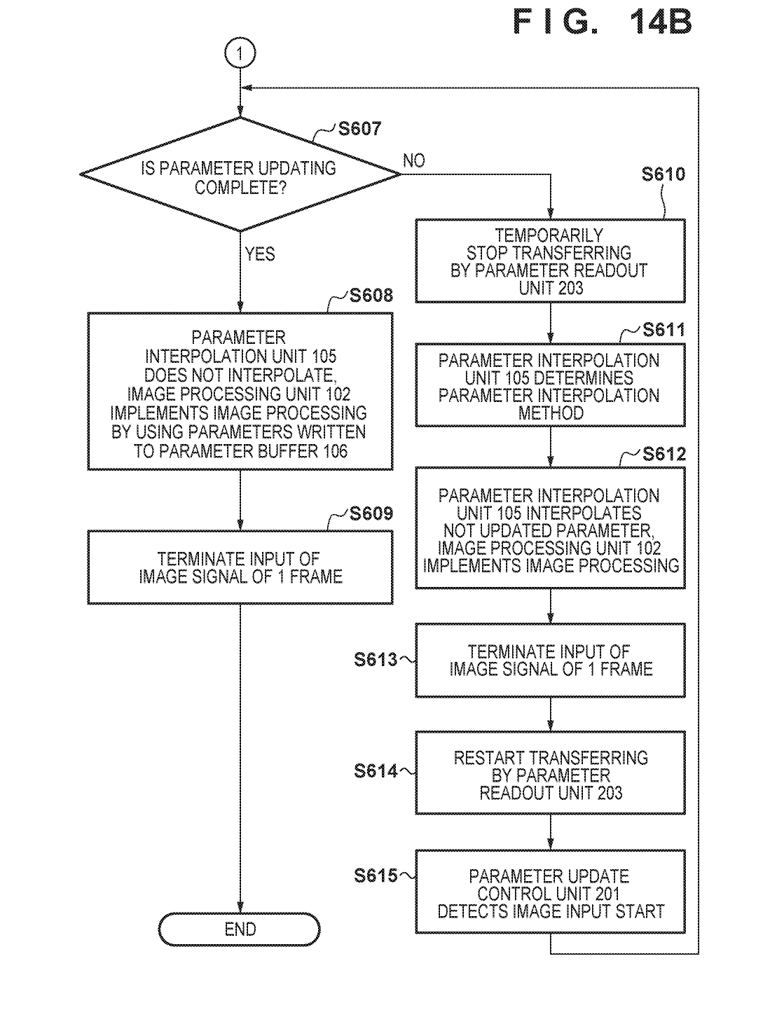

In the second embodiment, the flowcharts of FIGS. 14A and 14B are used to only describe difference with the first embodiment regarding a case of temporarily stopping parameter updating during input of an image signal. Processing of steps of S601 to S606 is similar to the processing of step S501 to step S506. The processing of step S607 is similar to the processing of step S509. Processing of step S608 to step S609 is similar to the processing of step S510 to step S511. Processing of step S611 to step S613 is similar to step S512 to step S514. The processing of step S615 is similar to the processing of step S516.

If parameter updating has not completed by starting point in time of an image signal input, the parameter update control unit 201 temporarily stops transfer of parameters by the parameter readout unit 203 (step S610). In the present embodiment, the parameter update control unit 201 temporarily stops the DMA controller. After completion of the image signal input, the parameter update control unit 201 restarts transfer of the parameters by the parameter readout unit 203 (step S614). In the present embodiment, the parameter update control unit 201 restarts the DMA controller that had been temporarily stopped.

In this way, according to the present embodiment, it is possible to update parameters during the parameter update interval while allocating memory bandwidth during image processing. Even if parameter updating is performed over a plurality of image frame intervals, it is possible to make image degradation smaller by performing interpolation.

### Third Embodiment

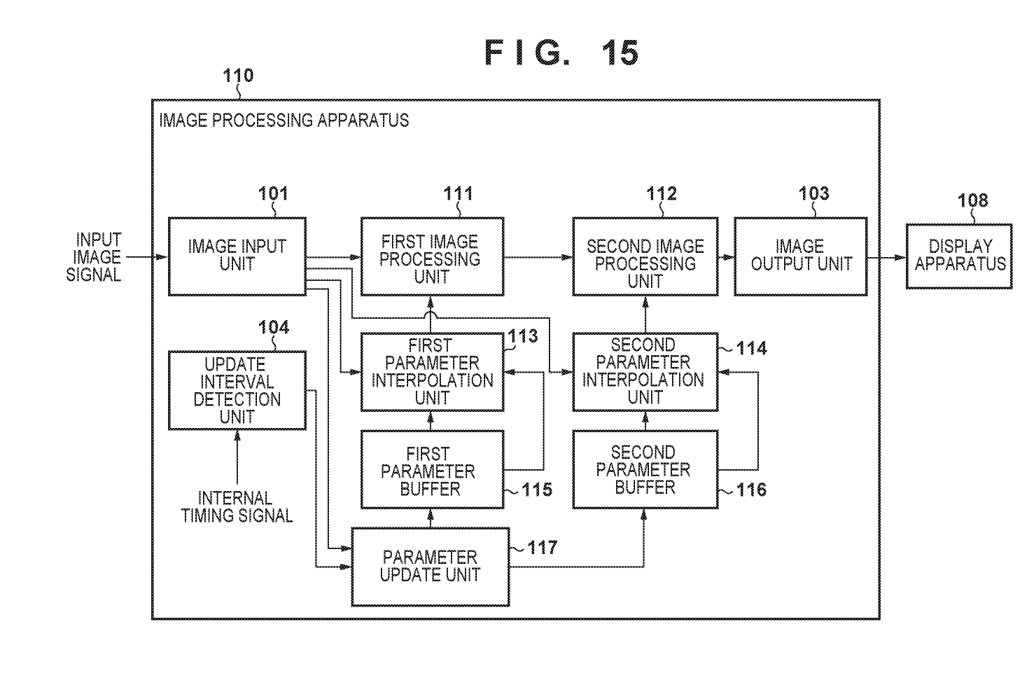

In the third embodiment, description is only given of difference with the first embodiment for a case of having a plurality of image processing units. FIG. 15 is used to give a description regarding processing of the image processing apparatus 110 of the third embodiment. FIG. 15 is a view illustrating an example of a configuration of the image processing apparatus 110 in the present embodiment. The image processing apparatus 110 has two image processing units, two parameter interpolation units, and two parameter buffers. A second image processing unit 112 is connected to a subsequent stage of a first image processing unit 111. An image signal from the image input unit 101 is subject to image processing by the first image processing unit 111, then subject to image processing by the second image processing unit 112, and output to the image output unit 103. By a similar method to the above embodiments, the first image processing unit 111 reads parameters from a first parameter buffer 115 via a first parameter interpolation unit 113. Similarly, the second image processing unit 112 reads from a second parameter buffer 116 via a second parameter interpolation unit 114. Note that image processing may be performed by two or more stages, and accordingly there may be two or more the image processing units, parameter interpolation units and parameter buffers.

Explanation is given regarding a parameter update unit 117 of such an example of having a plurality of image processing stages. In the first embodiment, the table data is divided into four and stored in the main memory 204.

First parameter: 4*N(N=0, 1, . . . 256/4−1),

Second parameter: 4*N+2(N=0, 1, . . . 256/4−1),

Third parameter: 4*N+1(N=0, 1, . . . , 256/4−1)

Fourth parameter: 4*N+3(N=0, 1, . . . 256/4−1)

In the present embodiment, parameters are respectively divided into the first image processing unit 111 and the second image processing unit 112, and can be arranged to be mixed in the main memory 204. An example is illustrated below.

First parameter: 4*N of the first image processing unit 111

(N=0, 1, . . . 256/4−1)

Second parameter: 4*N of the second image processing unit 112

(N=0, 1, . . . 256/4−1)

Third parameter: 4*N+2 of the first image processing unit 111

(N=0, 1, . . . 256/4−1)

Fourth parameter: 4*N+2 of the second image processing unit 112

(N=0, 1, . . . 256/4−1)

Fifth parameter: 4*N+1 of the first image processing unit 111

(N=0, 1, . . . 256/4−1)

Sixth parameter: 4*N+1 of the second image processing unit 112

(N=0, 1, . . . 256/4−1)

Seventh parameter: 4*N+3 of the first image processing unit 111

(N=0, 1, . . . 256/4−1)

Eighth parameter: 4*N+3 of the second image processing unit 112

(N=0, 1, . . . 256/4−1)

In addition, a transfer order may be changed in accordance with details of image processing. For example, a case in which image degradation for image processing by the first image processing unit 111 is processing that is easier to notice than image processing by the second image processing unit 112 is envisioned. In such a case, in the following way, configuration may be taken such that an update order is the parameter update unit 117 first sends a minimum of image processing parameters to the first image processing unit 111 and the second image processing unit 112. And subsequently, the parameter update unit 117 sends all parameters of the first image processing unit 111.

First parameter: 4*N of the first image processing unit 111

(N=0, 1, . . . 256/4−1)

Second parameter: 4*N of the second image processing unit 112

(N=0, 1, . . . 256/4−1)

Third parameter: 4*N+2 of the first image processing unit 111

(N=0, 1, . . . 256/4−1)

Fourth parameter: 4*N+1 of the first image processing unit 111

(N=0, 1, . . . 256/4−1)

Fifth parameter: 4*N+3 of the first image processing unit 111

(N=0, 1, . . . 256/4−1)

Sixth parameter: 4*N+2 of the second image processing unit 112

(N=0, 1, . . . 256/4−1)

Seventh parameter: 4*N+1 of the second image processing unit 112

(N=0, 1, . . . 256/4−1)

Eighth parameter: 4*N+3 of the second image processing unit 112

(N=0, 1, . . . 256/4−1)

The parameter update control unit 201 sets the parameter readout unit 203 so that reading is performed in an order from the first to the eighth parameters. The parameter update control unit 201 sets address control in the parameter write unit 202 such that the first to eighth parameters are written to suitable addresses of the first parameter buffer 115 and the second parameter buffer 116.

According to the present embodiment, it is possible to maintain consistency of image processing and perform image processing having low image degradation by sending a minimum data that can be interpolated to the first image processing unit 111 and the second image processing unit 112. Furthermore, it is possible to make image degradation smaller by further sending remaining divided data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-230693, filed Nov. 26, 2015, which is hereby incorporated by reference herein in its entirety.

What is claimed is:

1. An image processing apparatus that performs image processing on an image, comprising:
a writing unit configured to write a parameter used for performing the image processing to a memory;
an interpolation unit configured to use, out of a plurality of parameters used to perform the image processing, the parameter written to the memory to interpolate and generate a parameter not written to the memory by the writing unit; and
an image processing unit configured to perform the image processing by using the parameter written to the memory by the writing unit and the parameter interpolated and generated by the interpolation unit by using the parameter written to the memory.

2. The image processing apparatus according to claim 1, wherein the writing unit divides a plurality of parameters into a plurality of groups, and writes a parameter for each group to the memory.

3. The image processing apparatus according to claim 2, wherein a consecutive identification number is associated with each of the plurality of parameters, and the groups include parameters having identification numbers of a predetermined interval.

4. The image processing apparatus according to claim 3, wherein the interpolation unit interpolates and generates the parameter not written to the memory by using a parameter that is written to the memory and has an identification number adjacent to an identification number corresponding to the parameter.

5. The image processing apparatus according to claim 1, wherein if not all of the plurality of parameter used to perform the image processing are written to the memory, the interpolation unit determines an interpolation method and uses the determined interpolation method to interpolate and generate a parameter that is not written to the memory.

6. The image processing apparatus according to claim 1,
further comprising a specification unit configured to specify a start timing of an interval for updating a parameter for performing the image processing,
wherein the writing unit writes the parameter to the memory in accordance with specified start timing.

7. The image processing apparatus according to claim 6, wherein the start timing is a timing that is not during an interval in which the image processing is performed by the image processing unit.

8. The image processing apparatus according to claim 1, wherein the writing unit, in a case of detecting input of an image to the image processing apparatus during writing of a parameter to the memory, stops writing of the parameter to the memory.

9. The image processing apparatus according to claim 8, wherein if the image processing unit completes image processing for the input image, the writing unit restarts writing of the parameter to the memory.

10. The image processing apparatus according to claim 1,
wherein the image processing unit has a first image processing unit for performing first image processing and, connected to a subsequent stage of the first image processing unit, a second image processing unit for performing second image processing, and
wherein the first image processing unit and the second image processing unit use the parameter written to the memory and the generated parameter to respectively perform the first image processing and the second image processing.

11. A method of controlling an image processing apparatus that performs image processing on an image, the method comprising:
writing a parameter used for performing the image processing to a memory;
using, out of a plurality of parameters used to perform the image processing, the parameter written to the memory to interpolate by the writing and generate a parameter not written to the memory; and
performing the image processing by using the parameter written to the memory by the writing and the parameter interpolated and generated by using the parameter written to the memory.

12. A non-transitory computer-readable storage medium storing a computer program for causing a computer to execute a control method of an image processing apparatus, the method comprising:
writing a parameter used for performing the image processing to a memory;
using, out of a plurality of parameters used to perform the image processing, the parameter written to the memory to interpolate by the writing and generate a parameter not written to the memory; and
performing the image processing by using the parameter written to the memory by the writing and the parameter interpolated and generated by using the parameter written to the memory.
